(19) United States
(12) Patent Application Publication
(10) Pub. No.: US 2020/0126120 A1
(43) Pub. Date: Apr. 23, 2020

(54) RECONSTRUCTING BROWSING HISTORIES

(71) Applicant: OGURY Ltd, London (GB)

(72) Inventors: Vincent Bachelier, Sartrouville (FR); Philippe Périé, Paris (FR); Pierre Formont, Asnières (FR); Rémi TAKASE, Paris (FR); Christophe Thibault, Paris (FR); Chen Zang, Sartrouville (FR)

(21) Appl. No.: 16/163,396

(22) Filed: Oct. 17, 2018

(51) Int. Cl. G06Q 30/02; G06F 17/30

(52) U.S. Cl. CPC G06Q 30/0255; G06F 17/30864

(57) ABSTRACT

A server to reconstruct a browsing history of a mobile device, including an internet crawling module to initiate an internet crawling application to receive a generated website signature descriptive of internet protocol (IP) addresses' access to a website and its associated resources; a transmission control protocol (TCP) reception module to receive a created signal descriptive of a TCP packet comprising IP addresses of resources received and stored on a mobile device; and a processor to compare the signature with the signal to determine if a computing device associated with the signature accessed the website associated with the signal address in order to reconstruct the browsing history.

### BACKGROUND

Smartphones have become increasingly ubiquitous in humanities' daily life. Smartphones usually possess extensive computing capabilities such as high-speed access to the internet over a Wi-fi or mobile network, Bluetooth communication, global positioning satellite navigation, and digital gaming capabilities, among others.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a server to reconstruct a browsing history of a mobile device according to an example of the principles described herein.

FIG. 2 is a block diagram of a system for customizing an advertising campaign according to an example of the principles described herein.

FIG. 3 is a flowchart showing a method (300) of reconstructing a browsing history according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Some entities have taken advantage of the myriad activities a user may engage in connection with the use of a smartphone. With the execution of any mobile app (applications capable of being executed on a smartphone) a user may be presented with a number of advertisements. These advertisements may be presented to a user during the execution of the mobile app due to the inclusion of a software development kit embedded into the developers' mobile app. In most cases, the inclusion of the advertisements associated with the mobile app provide a means by which the mobile app developer may be monetarily compensated for developing and managing the development of the mobile app.

In some examples, the information used to determine which advertisements to present to a user during execution of the mobile app included a user's internet browsing history. By using a user's internet browsing history, the advertisements presented to a user engaging with a mobile app may be tailored to that user's specific interests, needs, and past activities. In most cases, these tailored advertisements may be presented to the user in order to create advertising revenue for the mobile app developer.

Besides presenting a platform by which advertising revenue may be created, the user's browsing history may also be used to further investigate the interests of any particular or type of user executing the mobile app. This may further help marketers and publishers of mobile apps to discern how to best direct their advertisements over certain demographics of the users of any given mobile app. Indeed, among the myriad of different mobile apps there exits classes of mobile apps: gaming apps, business apps, dating apps, communication apps, art and design apps, entertainment apps, financing apps, and education apps, among others. Thus, based on the class of the mobile app being used by any given user, marketers and publishers of mobile apps may coarsely refine the type of advertisements directed to any give user of any given mobile app.

However, with the advent of certain advancements in operating systems such as the Android® operating system, the ability to implement a user's browsing history in order to customize advertisements presented to a user has been diminished. (Android® is a mobile operating system developed by Google®.) Indeed, with the development of Android 6.0, certain permissions associated with mobile devices that allowed access to a user's browsing history via execution of any given mobile app have been removed. This change in the possibility to get the browsing history of a user of a mobile device, whatever the purpose in such a change, poses a risk that can prevent the marketers and publishers of mobile apps from discerning what types of advertisements to present to a potential user of any given mobile app.

The present specification describes a method and system that, despite not having access to a user's browser history on a mobile device, reconstructs that browsing history of a user. The reconstruction of the user's browsing history is done to tailor advertisements presented to a user of a mobile app. The reconstruction of any given user's browser history involves the creation of one to several signatures that characterize a website. An internet crawler may be used to create these signatures: information descriptive of one to several internet protocol (IP) addresses associated with the servers hosting the primary and secondary resources. Reconstruction of the user's browsing history also includes implementing receiving a created signal descriptive of the transmission control protocol (TCP) packets comprising several IP addresses of resources received and stored on a mobile device. By comparing the signatures and the signals, a reconstruction of the activities or browsing history of the user of a mobile device may be accomplished.

The present specification describes a computer program product for reconstructing a browsing history. The computer program product includes a computer readable storage medium comprising computer usable program code embodied therewith, the computer usable program code to, when executed by a processor: receiving generated websites signatures descriptive of the lists of internet protocol (IP) addresses used to access to different websites and their resources; collecting the created signal descriptive of TCP packets of IP addresses of the resources received and stored on a mobile device; and comparing the IP addresses from the signatures with the IP addresses from the signals to determine if a computing device associated with some given signals accessed the website associated with given signatures.

The present specification further describes a server to reconstruct a browsing history of a user on a mobile device. It consists of an internet crawling module that initiates an internet crawls, a transmission control protocol (TCP) reception module to receive the packets, that will form the websites signature. In an example, for each website, the web crawler may determine any primary and secondary resources presented on the website within a given period; determine any IP addresses associated with each of the primary and secondary resources within any given period; and associate the resources accessed with specific IP addresses. Secondary IP addresses are external resources that help websites to function but are not part of the website.

The present specification also describes system for customizing an advertising campaign, including a server to: initiate an internet crawling application to receive a generated website signature; receive a created signal descriptive of the TCP packets received and stored on a mobile device; compare the generated signatures with the signals collected on the device in order to reconstruct the browsing history; and send data to the mobile device indicating which advertisements to present to a user during execution of a mobile app on.

As used in the present specification and in the appended claims, the term “internet” is meant to be understood as a worldwide collection of interconnected networks that use the internet suite of protocols (Internet Protocol, IP). In any example presented herein, the term internet may be interchangeable with the term “intranet” the former being a network that is internal to an organization alone. In either example, however, certain internet protocols are used that allow any number of computing devices to, either over a wire or wirelessly, communicate with each other.

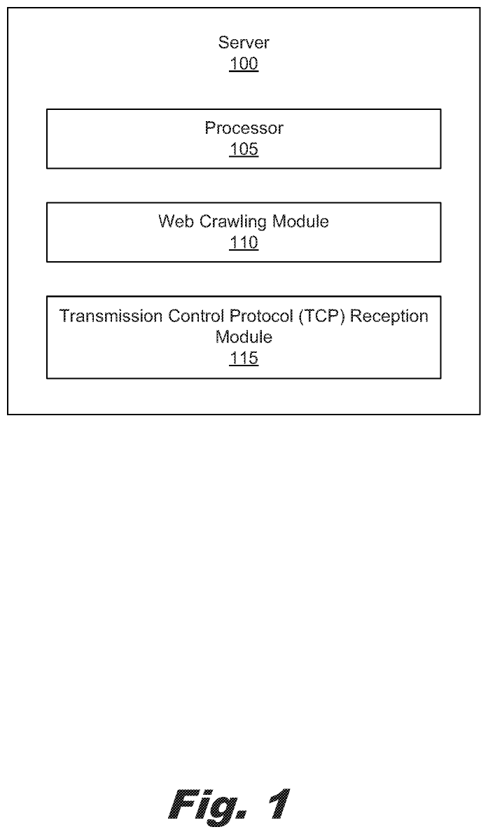

Turning now to the figures, FIG. 1 is a block diagram of a server (100) to reconstruct a browsing history of a mobile device according to an example of the principles described herein. The server may be any type of computing device communicatively coupled to several other computing devices over a network. Accordingly, the server (100) may be utilized in any data processing scenario including, stand-alone hardware, mobile applications, through a computing network, or combinations thereof. Further, the server (100) may be used in a computing network, a public cloud network, a private cloud network, a hybrid cloud network, other forms of networks, or combinations thereof. In one example, the methods provided by the server (100) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (laaS) hosting equipment such as, for example, servers, storage components, network, and components, among others; application program interface (API) as a service (APlaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the server (100) are executed by a local administrator.

To achieve its functionality as described herein, the server (100) comprises various hardware components. Among these hardware components may be a number of processors (105), a number of data storage devices, a number of peripheral device adapters, and a number of network adapters. These hardware components may be interconnected through the use of a number of busses and/or network connections. In one example, the processor, data storage device, peripheral device adapters, and a network adapter may be communicatively coupled via a bus.

The processor (105) may include the hardware architecture to retrieve executable code from the data storage device and execute the executable code. The executable code may, when executed by the processor, cause the processor (105) to implement at least the functionality of receiving a generated website signature consisting of one to several internet protocol (IP) addresses associated with the servers hosting the primary and secondary resources; receiving a created signal descriptive of TCP packets several IP addresses of resources received and stored on a mobile device; and comparing the signature with the signals to determine if a computing device associated with the signals accessed the website associated with the first signatures, according to the examples of the methods described in present specification. In the course of executing code, the processor (105) may receive input from and provide output to a number of the remaining hardware units.

The data storage device may store data such as executable program code that is executed by the processor (105) or other processing device. The data storage device may specifically store computer code representing a number of applications that the processor (105) executes to implement at least the functionality described herein. The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor (105) may boot from Read Only Memory (ROM), maintain nonvolatile storage in the Hard Disk Drive (HDD) memory, and execute program code stored in Random Access Memory (RAM).

In the examples presented herein, the data storage device may include a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the server (100) enable the processor (105) to interface with various other hardware elements, external and internal to the server (100). For example, the peripheral device adapters may provide an interface to input/output devices, such as, for example, display device, a mouse, or a keyboard. The peripheral device adapters may also provide access to other external devices such as an extemal storage device, a number of network devices such as, for example, servers, switches, and routers, client devices, other types of computing devices, and combinations thereof.

The display device may be provided to allow a user of the server (100) to interact with and implement the functionality of the server (100) described herein. The peripheral device adapters may also create an interface between the processor (105) and the display device, a printer, or other media output devices. The network adapter may provide an interface to other computing devices (i.e., client devices) within, for example, a network, thereby enabling the transmission of data between the server (100) and other devices located within the network.

The server (100) may, upon execution of computer readable program code by the processor, display the number of graphical user interfaces (GUIs) on the display device associated with the executable program code representing the number of applications stored on the data storage device. The GUIs may include aspects of the executable code including display of the website signature descriptive of a first internet protocol (IP) addresses' access to a website resource; displaying of the signals descriptive of a TCP packet comprising a second IP address of a resource received and stored on a mobile device, and displaying of the comparison of the first IP address with the second IP address to determine if a computing device associated with the second IP address accessed the website associated with the first IP address. Additionally, via making a number of interactive gestures on the GUIs of the display device, a user may interact with the data received by the server (100) in order to reconstruct a browsing history of a user. Examples of display devices include a computer screen, a laptop screen, a mobile device screen, a personal digital assistant (PDA) screen, and a tablet screen, among other display devices. Examples of the GUIs displayed on the display device.

The server (100) further comprises a number of modules (110, 115) used in the implementation of the methods described herein. The various modules (110, 115) within the server (100) comprise executable program code that may be executed separately. In this example, the various modules (110, 115) may be stored as separate computer program products. In another example, the various modules (110, 115) within the server (100) may be combined within a number of computer program products; each computer program product comprising a number of the modules (110, 115). In an example, the modules (110, 115) described herein may take on the form of an application specific integrated circuit (ASIC) that, when accessed by the processor (105), executes the processes and methods described herein.

The server (100) may include an internet crawling module (110). The internet crawling module (110) may, when executed by the processor (105) for example, initiate an internet crawling application to receive a generated website signature consisting of one to several internet protocol (IP) addresses associated with the servers hosting the primary and secondary resources. In an example, the internet crawling module (110) receives a plurality of generated website signatures descriptive of a, respective, plurality of IP addresses' access to a website resource.

In an example, the internet crawling module (110) may initiate an internet crawler to, first, generating a specific signature for given website. This signature includes a list of IPs that is as close as possible to what a real user or plurality of users would generate when navigating on that given website. Thus, the internet crawler may be initiated at any number of websites. The whole internet can be represented as a connected graph whose vertices are the websites. This may be referred to as a topography of a network of computers distributed over a website or a plurality of websites. Each website requests access to primary and secondary resources when called to retrieve and display information correctly, depending on the context of the request. Each resource is hosted by servers whose addresses in the network are handled by IP protocol. Consequently, the web crawling module (110) may initiate a web crawler to create a number of topography graphs representative of a plurality of websites to be monitored by the server (100) described herein.

As a consideration, it is to be noted that these topographical graphs are dynamic in that some links between some websites and resources may change several times a day. However, there may be relatively more static websites that do not change at all but the present specification contemplates that the web crawling module (110) initiates a web crawler to determine the topographical graph of any given website. Even further, information associated with the internet protocol (IP) addresses' access to any given website resource associated with the servers hosting the primary and secondary resources may also change for some resources. The web crawler initiated by the web crawling module (110) may, therefore, form the topographical graph corresponding to the monitored websites any number of times during operation of the server (100).

With the topographical graphs, the website signatures descriptive of any number of internet protocol (IP) addresses' access to a website resource may be generated. In an example, for each website, the web crawler may determine any primary and secondary resources presented on the website within a given period of time; determine any IP addresses associated with each of the primary and secondary resources within any given period of time; and associate the resources accessed with specific IP addresses.

With the web crawler, any given websites' resources may be determined using one or a combination of three distinct processes. In a first process, any given websites' content may be downloaded using a dedicated tool such as GNU Wget that includes computer readable program code that retrieves content from web servers. However, with the implementation of GNU Wget, resources that implement javascript cannot be executed with GNU Wget and therefore, the web crawler will miss some of the resources on the website such as ads, feeds, images, and other objects fetched using javascript, among others.

In an alternative example, the website's resources may be determined by opening any individual web pages of a website using voice-over internet-protocol (VoIP) methods. In this example, a number of digital or real phones may be implemented along with a device framing service. However, with this method, the scalability may be relatively difficult to achieve and the costs may exceed the benefits received as compared to other methods. Even further, virtual private networks (VPN) may not allow VoIP communication and, therefore, may limit the abilities to determine any given resource on a website.

In an alternative example, a headless browser application may be used to determine the resources of any given website. In this example, the headless browser (a browser executed via a command-line interface or using a network connection) may emulate a navigation through a website of a mobile device. This example is scalable using a plurality of headless browsers executed on any number of computing devices. Additionally, the headless browser is executable on a website even where the website is operated on a VPN. Still further, the headless browser may determine the resources that use javascript. Even further, the use of the headless browser may be most similar to the execution of an actual browser accessing resources on any given website by a mobile device. In the examples presented herein, the process will be described in connection with the use of a headless browser. However, the present specification contemplates the use of any other process of determining resources available on any given website.

Before initiating the web crawler using the headless browser, a list of websites to crawl may be developed. Any method may be used to determine which websites to crawl. In an example, the determination of which websites to crawl in the process includes determining from a number of entities associated with any number of mobile apps a list of websites those entities wish to crawl. This may be based on economic interests of the entities. In an example the determination of which websites to crawl in the process includes crawling the most visited websites. The top most visited websites may be based on geographical areas such that those most visited websites may be different from one country to another. The top most visited websites may be determined using research organizations such as Alexa® Top Sites organization found at https://www.alexa.com/topsites. Alexa® is a virtual assistant device and associated websites created and maintained by Amazon®. Alexa® Top Sites provides an application program interface (API) used to retrieve the top sites and their ranks for each country for a number of given periods of time. From this list or any other list provided by any number of other organizations, the results may be filtered to remove some websites that are relatively too common or lack specific interest of focus to a mobile app developer. In an example, this list of sites to be crawled by the web crawler may be saved on a data storage device of the server (100) for access by the server (100) during the processes and methods described herein.

Once the list of websites to crawl has been developed, the server (100) may begin to receive a generated website signature descriptive of internet protocol (IP) addresses used by a website and its resources via execution of the web crawling module (110). In an example, these signatures may be made to be as close as possible to an actual real-life situation. Thus, the web crawler may simulate real connections of a mobile device accessing any given website. As such, the web crawler may be implemented at the same geographical location as that of the mobile device the server (100) is attempting to reconstruct the browsing history of. Additionally, similar resolutions representative of that presented on a type of mobile device, browsing applications that act similar to actual browsing applications, and actions engaged in on a website (image loading, scrolling, and script loading) will be engaged in by the we crawler in order to achieve a real-life simulation.

The web crawling process executed by the web crawling module (110) may be initiated using a scheduling application. Any number of iterations and/or any timing of the execution of the web crawler initiated by the web crawling module (110) is also contemplated and in an example, may be accomplished on a daily basis. During the crawling, the server (100) may implement any number of computing devices (hardware and/or virtual computing devices) to access the list of websites and initiate the web crawler on any given website using a queuing process, for example.

During the web crawling process, the websites may be opened using a “mobile mode” such that what is accessed is similar to that accessible to the mobile device. A mobile mode may include a request to a website that is specific to a mobile device and/or a particular manufacturer, type, and/or model of the mobile device. During access to the website, the web crawler may wait for the webpage of the website to completely load. Any alerts or confirmation messages (pop-ups, cookie notifications, etc.) loaded with the web page may be handled by the web crawler to be loaded and addressed in order to access the web page itself. Also, during access to the website, the web crawler may scroll a few seconds or a set period of time in order to allow the entirety of the page to load. A list of network calls may also be dumped. During this process, for each website, a list of uniform resource locators (URLs) that have been called may be recorded to the data storage device of the server (100). Because a majority of the URLs associated with a webpage recorded by the web crawler are hosted on a single domain, the URLs may be associated with that domain in the data storage device.

The process executed by the server (100) may further include resolving any IP address associated with any of the domains determined to exist with the web crawler. The IP addresses may be retrieved by calling the name servers. Each name server will return any number of IP addresses for any given domain. The information may be cached on the name servers to speed up future requests from the server (100). The domain can have different configurations and it may be common to have merely a portion of the IP addresses behind a domain and/or IP addresses which are close to the user that requests the IP addresses. In order to get the most extensive list of IP addresses behind a domain, the server (100) may call the name servers as often as possible.

Resolving the IP addresses of the domains may include, first, fetching a list of name servers from a public name server repository such as https://public-dns.info. This particular website may contain hundreds of public name servers available and may group the name servers by country thereby rendering the name server search easier. Calling the name servers may be spread across any number of computing devices (hardware or virtual) such as the server (100). The requests to the name servers may be done randomly in order to avoid any limitations on access speeds to the name servers as well as any possible banishment from access. Additionally, a time-to-live (TTL) limitation may be implemented that sets a duration of time that the server (100) is to receive a response. This may be done in order to avoid useless resolution freeing up time for other calls to other name servers. As a result of accessing the name servers, a list may be created by the processor (105) of the server (100) with each domain have associated IP addresses listed.

As a result of initiating the web crawler by the web crawling module (110), a verbose amount of information may be retrieved from the various websites and name servers. In an example, the information may include a summary of the web site, the web site's domain, the websites' main domain, any IP addresses having accessed the website, and the date this information was gathered by the web crawler initiated by the web crawling module (110). However, in an example the summary may be limited to include those distinct IP addresses and not duplications of the same IP address that indicates a certain client device accessed the website multiple times.

After receiving a number of generated website signatures descriptive of a number of internet protocol (IP) addresses' access to a number of website resources, a weight may be assigned to each IP address. This is done in order to prepare for comparing the number of IP address (website signatures) with other IP addresses (signals descriptive of a TCP packet received from a mobile device comprising an IP address). In an example, the weight of an IP address may be expressed as the inverse of the number of sites sharing it. The purpose behind this formula may be to indicate that the more an IP address is shared the less it is relevant as a data point. Because the web crawler described herein collects more IP addresses than those collected from the transmission control protocol (TCP) packets on a number of mobile devices, a relatively large number of signatures are created leading to a very high computation time and cost during the comparison process.

To rectify this, in each signature, all IP addresses shared by more than 1000 websites are filtered out except those primary IP addresses. In an example, those IP addresses not collected by the software development kit of the mobile devices are also filtered out. By way of example, currently any unfiltered signatures originating from, for example, France (for about 60,000 websites) results in a collection of 3 million IP addresses. However, after filtering these results, 160,000 IP address are kept as valuable data points.

Even if a signature may be used as a representation of a website using the collection of IP addresses that can be potentially called when a user access it, the actual implementation and storage of theses signatures may be more IP address-centric than website-centric in order to facilitate the comparison. In an example, the actual implementation is a representation of this information as indicated by the following computer readable program code:

```
{
        ip1:
            {
                Weight: 0.5
                Sites: ((s1, 1), (s2, 0))
            },
        ip2:
            {
                Weight: 0.0001
                Sites: ((s3, 1))
            }
}
```

In this example, ip1 is shared among sites s1 and s2, hence a weight of 0.5. ip1 is primary for site s1, indicated by a one (s1,1) and secondary for site s2, indicated by a zero (s2,0)

It is notable that ip2 is kept in the signatures despite its small importance (<1/1000). Indeed, even if this IP address (ip2) is shared by as large as 10000 sites, one site uses this IP as primary (s3) so that may be a reason as to why this information is kept during the implementation.

While accessing a website, a mobile device connects to both the server on which the HTML code of the website is hosted (called a “primary resource”) as well as to multiple external resources (secondary resources) such as CDN, Facebook® “likes”, ad trackers, etc. (Facebook® is a social media company based in Menlo Park, Calif.). All these network connections leave traces that are used to store information about user's browsing information on the mobile device. Specifically, when browsing the Internet, multiple TCP connections are opened, allowing the mobile device and the servers of all resources of the website to exchange data packets. These data packets include information about TCP sockets thereby providing the history of accessed websites. This information is may be automatically stored on the mobile device by its operating system. In the example where the operating system is an Android-based operating system, these data packets may be stored under the file name of /proc/net/tcp). Because this file is stored by the operating system of the mobile device, a software development kit (SDK) originating with the server (100) and executed by an application running on the mobile device can retrieve all the connections opened and closed and their specific IP addresses. More precisely, the SDK may direct that a buffer maintains all IP addresses to which a connection has been made.

The SDK may provide this information to the server (100) and specifically the transmission control protocol (TCP) reception module (115) by reading this file at a regular basis (i.e., every 15 seconds) and sending that information to the server (100). In an example, when this buffer file exceeds 100 IP address, the data is sent to the server (100) and stored thereon. The buffer file may then be cleaned, and the same operation may be repeated any number of iterations. These streams of IP addresses received by the server (100) (i.e., the created signal descriptive of a TCP packet comprising a second IP address of a resource received and stored on a mobile device) provides data on the websites the user has visited using the mobile device. In an example, where multiple connections are opened to an IP address while filling the buffer of the mobile device, the first time the IP address is written may be kept while deleting the remaining instances. Therefore, in the case where a shared IP address is called several times by multiple websites, the TCP associated with a first connection is stored.

However, under the thus far described process, the collected TCP packets may be degraded and some IP addresses may be dropped or those IP addresses that are to be determined to be not relevant anymore but are still included in the output from the TCP packets received by the TCP reception module (115). Consequently, it may be difficult to rebuild a browsing history with accurate times. To alleviate this, these signals may be clustered into signal sessions. Specifically, the processor (105) may decompose the continuous flow of TCP packets from the mobile device such that the IP addresses associated with each of the TCP packets are grouped into clusters. This grouping may be done such that any two IP addresses are determined to be included in the same session if the timestamp difference between any given two IP addresses is less than a given threshold. An example threshold time may be 5 minutes such that any two IP addresses that include a time stamp having a difference of 5 minutes or greater are determined to be within two different signal sessions. Similarly, any two IP addresses that include a time stamp having a difference of less than 5 minutes may be determined to be within the same session. The present specification, however, contemplates the use of any other length of time to serve as the threshold duration between timestamps on any given TCP packet received by the TCP reception module (115) from a mobile device. As such and after the TCP signals and their respective IP addresses have been grouped into these clusters, the processor (105) may then compare any of the IP addresses associated with the signatures with the IP address associated with the signals in order to determine if a computing device associated with the signals accessed any website associated with the signatures so as to reconstruct the browsing history of a mobile device or other computing device.

In any example presented herein, the comparison of the signatures and the signals may include a number of sub-processes. In an example, the comparison of the signatures and the signals may include filtering the signatures by IP addresses during a session so that a list of candidate websites is maintained.

In an example, for each candidate website, if any of the website's primary resource is (defined by an IP labeled as “primary”) called, this IP address may be removed. A score may then be calculated for each candidate website by choosing a the greatest of a weight value of its associated IP addresses and multiplying that by a probability P(s) of a user visiting a site. Each of these scores may be kept above a threshold scoring value.

Specifically, for a given website “s”, a prior probability “P(s)” may be defined as a probability that a user navigates on this specific website if any other information is not available. Indeed, a prior probability may measure the probability that an event happens if evidence regarding the navigation to the website is not considered. By way of example, the prior probability associated with the Google@ website or Facebook® website may be relatively higher than any other websites because these specific example websites are the most visited sites in the world. Google@ LLC is a multinational technology company based in Mountain View Calif. This quantity “P(s)” may, in an example, be estimated using a page view/million presented by Alexa at https://www.alexa.com/topsites. Page view/million represents the number of page views attributed to any specific website in a sample of one million user visits. In this example, therefore, the estimation of P(s) may be:

$$P ( s ) = \frac{page view \text{/} million}{1 \text{,} 000 \text{,} 000}$$

As for the scoring of each of the candidate websites, if an IP address is shared “n” number of websites, then the weight applied to the website will be 1/n. An IP address, again, is said to be a primary address for a given website when it belongs to the set of IP addresses of its primary domains. In an example, if an IP address belongs to a single website a weight assigned to the IP address may be 1. In most circumstances, however, an IP address is shared by many websites. However, a user of a mobile device may have visited one or two of those websites. Since some websites are more likely to be visited than others, the weight of each IP address may be multiplied by the prior of the associated websites so that the most probable ones have the greatest scores.

Where, for example, a session contains four IP addresses, during the process of filtering the signatures, candidate websites include s1, s2, s3, s4 to s10000 with the following characteristics:

| | | | | | | | | Resulting |
|---|---|---|---|---|---|---|---|---|
| IP address | s1 | s2 | s3 | s4 | s5 | | s10000 | Score |
| ip1 | primary | secondary | secondary | n/a | n/a | . . . | n/a | 0.33 |
| ip2 | n/a | n/a | primary | n/a | secondary | . . . | secondary | 0.0001 |
| ip3 | n/a | n/a | n/a | primary | n/a | . . .. | n/a | 1 |
| ip4 | primary | secondary | n/a | n/a | n/a | . . . | n/a | 0.5 |
| Prior | 0.1 | 0.05 | 0.2 | 0.1 | 0.1 | | 0.1 | |
| probability | | | | | | | | |

In this example, ip1 is shared across 3 sites, ip2 is shared across 9996 sites, ip3 is not shared, ip4 is shared across 2 sites. Hence score(ip1)=1/3, score(ip2)=0.0001, score(ip3)=1, so score(ip4)=0.5

In this example and because s2 and s5 to s10000 have no primary IP address called, they may be removed from the comparison process. It can then be determined, via website analysis, that P(s1)=P(s4)=0.1 and P(s3)=0.2. Thus, the respective scores may be:

score(s1)=max(0.33,0.5)×0.1=0.05

score(s3)=max(0.33,0.0001)×0.2=0.066

score(s4)=max(1)×0.1=0.1

Consequently, if the threshold scoring value is set to 0.1, the website s4 is selected and used to compare the IP addresses associated with the signal descriptive of a TCP packet received and stored on a mobile device.

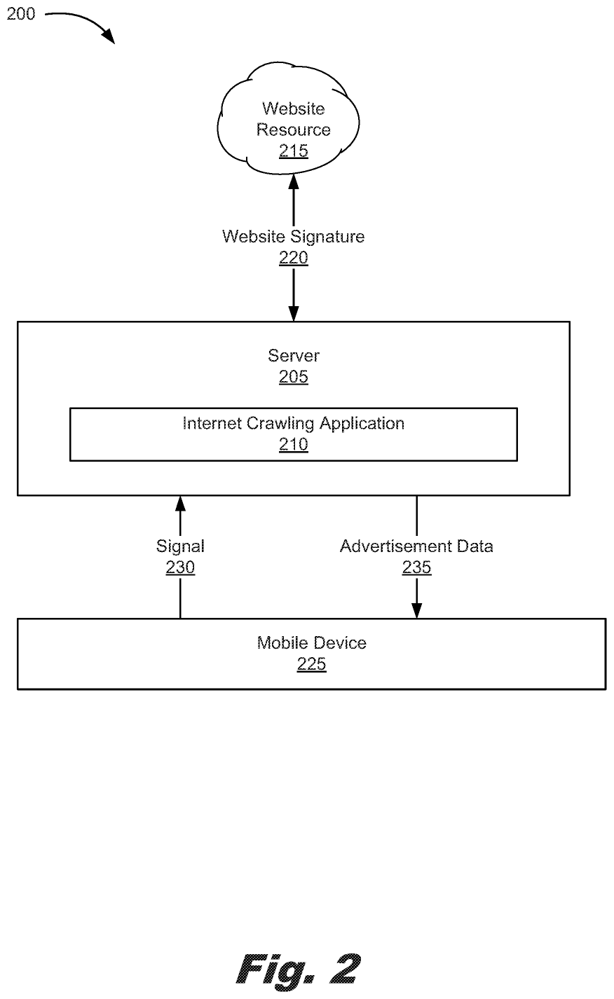

FIG. 2 is a block diagram of a system (200) for customizing an advertising campaign according to an example of the principles described herein. As described herein, the server (205) may initiate an internet crawling application (210) to receive a generated website signature (220) descriptive of a first internet protocol (IP) addresses' access to a website resource (215). The internet crawling application (210) may be executed by a processor of the server (200) and applied to a number of websites. The internet crawling application (210), when executed, may complete a number of tasks: determine the topography of any of a number of target websites; resolve any IP addresses of any domains by accessing a number of name servers; and create a summary describing a domain with respective IP addresses that accessed resources on that domain (i.e., website signatures (220) descriptive of a number of internet protocol (IP) addresses' access to a website resource (215)).

The server (205) may further receive a created signal (230) descriptive of a TCP packet comprising a second IP address of a resource received and stored on a mobile device (225). The signal and specifically the TCP packets may be maintained on the mobile device (225) under the direction of a software development kit (SDK). The SDK may have been uploaded by the mobile device (225) from the server (205). In an example, the SDK, or in particular the computer readable program code defining the SDK, may be uploaded along with a mobile app to be executed on the mobile device (225). It is this mobile app that the present system is attempting to customize an advertisement campaign on based on the reconstruction of the user's browsing history on the mobile device (225).

With the website signatures (220) and the signals (230), each IP address associated with the website signatures (220) may be compared with each IP address associated with the signals (230) as described herein. As a result of this comparison and matches between the IP addresses found within the signal (230) and the IP addresses found within the website signature (220), the browsing history of the user of the mobile device (225) may be reconstructed. Based on the reconstruction, data may be sent to the mobile device (225) indicating which advertisements to present to a user during execution of a mobile app on the mobile device (225).

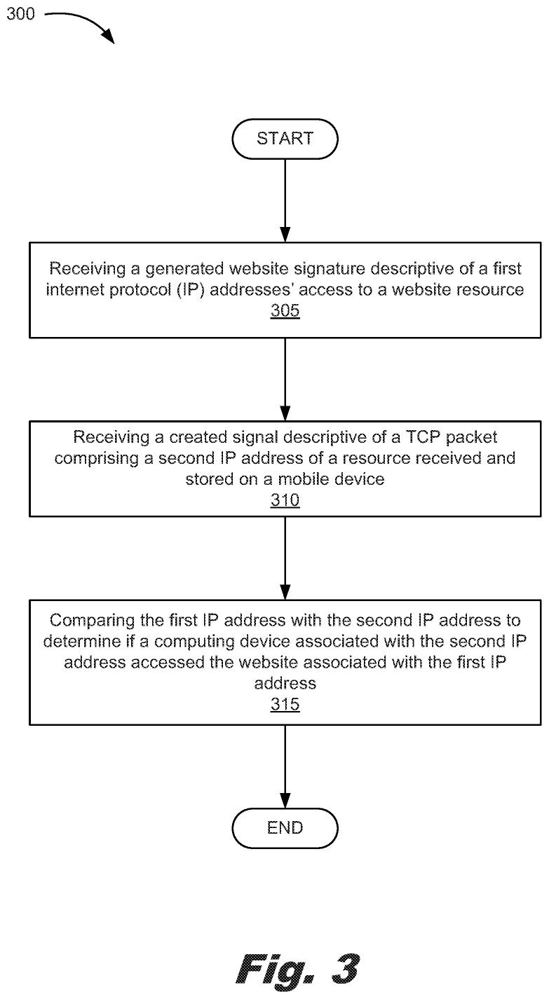

FIG. 3 is a flowchart showing a method (300) of reconstructing a browsing history according to an example of the principles described herein. The method (300) may start with receiving (305) a generated website signature descriptive of a first internet protocol (IP) addresses' access to a website resource. As described herein, the generated website signature is received using an internet crawler on a website associated with the website resource. In an example, the internet crawler iteratively reconstructs the website topography to maintain an up-to-date version of the topography of the website. Additionally, receiving the generated website signature descriptive of the first internet protocol (IP) addresses' access to the website resource includes calling a name server associated with a domain of the website.

The method (300) may continue with receiving (310) a created signal descriptive of TCP packets comprising IP addresses of resource received and stored on a mobile device. In an example, receiving the created signal includes receiving buffered sets of IP addresses accessed by the mobile device.

The method (300) may also include comparing the generated website signature descriptive of internet protocol (IP) addresses used by a website and its resources associated with the signal descriptive of TCP packets of several IP addresses of resources received and stored on a mobile device; and comparing the signature with the signals to determine if a computing device associated with the signal accessed the website associated with the signature.

In an example, the method (300) may include tailoring an advertising campaign to present to the mobile device based on the reconstructed browsing history. The tailoring of the advertising campaign may be based on the now reconstructed browser history. Indeed, the reconstructed browser history may provide a third party such as an advertising agent with an indication of the interest of the user of the mobile device. Indeed, with the reconstructed browser history, the user's past purchase history, viewing history, and other actions the user engaged in while viewing webpages on websites.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (105) of the computing device or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a method and system that, despite changes in an operating system of a mobile device, reconstructs a user's browsing history on a mobile device. Because some operating systems on mobile devices prevent third party mobile apps from accessing a user's browsing history, the user's browsing history may be reconstructed by comparing the website signatures with the signals as described herein.

The preceding description has been presented to illustrate and describe examples of the principles described. This description is not intended to be exhaustive or to limit these principles to any precise form disclosed. Many modifications and variations are possible in light of the above teaching.

What is claimed is:

1. A computer program product for reconstructing a browsing history, the computer program product comprising:
a computer readable storage medium comprising computer usable program code embodied therewith, the computer usable program code to, when executed by a processor:
receiving a generated website signature descriptive of internet protocol (IP) addresses used by a website and its associated resources,
receiving a created signal descriptive of a TCP packets of IP address received and stored on a mobile device; and
comparing the generated website signature descriptive of internet protocol (IP) addresses used by a website and its associated resources with signal descriptive of a TCP packets of IP address received and stored on a mobile device to determine if a computing device associated with the signal accessed the website associated with the signature.

2. The computer program product of claim 1, wherein the generated website signature is received using an internet crawler on a website associated with the website resource.

3. The computer program product of claim 2, wherein the internet crawler iteratively reconstructs the website topography to maintain an up-to-date version of the topography of the website.

4. The computer program product of claim 3, wherein receiving a generated website signature descriptive of a first internet protocol (IP) addresses' access to a website resource comprises calling a name server associated with a domain of the website.

5. The computer program product of claim 4, wherein the topography of the website is used to resolve that that first IP is associated with the website.

6. The computer program product of claim 1, wherein receiving the created signal comprises receiving buffered sets of IP addresses accessed by the mobile device.

7. The computer program product of claim 1, wherein comparing the signature with the signals comprise subjecting the first IP address to a filter to determine whether the first IP address is attributed to the website.

8. The computer program product of claim 1, comprising tailoring an advertising campaign to present to the mobile device based on the reconstructed browsing history.

9. A server to reconstruct a browsing history of a mobile device, comprising:
an internet crawling module to initiate an internet crawling application to receive a generated website signature descriptive of a first internet protocol (IP) addresses' access to a website resource;
a transmission control protocol (TCP) reception module to receive a created signal descriptive of a TCP packet comprising addresses of resources received and stored on a mobile device; and
a processor to compare the signatures with the signals to determine if a computing device associated with the signals accessed the website associated with the signatures in order to reconstruct the browsing history.

10. The server of claim 9, wherein the internet crawler iteratively reconstructs the website topography to maintain an up-to-date version of the topography of the website.

11. The server of claim 10, wherein receiving a generated website signature descriptive of internet protocol (IP) addresses' access to a website resource comprises calling a name server associated with a domain of the website.

12. The server of claim 11, wherein the topography of the website is used to resolve that that signature is associated with the website.

13. The server of claim 9, wherein receiving the created signal comprises receiving buffered sets of IP addresses accessed by the mobile device.

14. The server of claim 9, wherein comparing the signature with the signals comprises subjecting the signatures to a filter to determine whether the signature is attributed to the website.

15. The server of claim 9, comprising tailoring an advertising campaign to present to the mobile device based on the reconstructed browsing history.

16. A system for customizing an advertising campaign, comprising:
a server to:
initiate an internet crawling application to receive a generated website signature descriptive of internet protocol (IP) addresses' access to a website resource;
receive a created signal descriptive of a TCP packet comprising IP address of resources received and stored on a mobile device;
compare the signature with the signals to determine if a computing device associated with the signals accessed the website associated with the signatures in order to reconstruct the browsing history; and
send data to the mobile device indicating which advertisements to present to a user during execution of a mobile app on the mobile device.

17. The system of claim 16, wherein the generated website signature is received using an internet crawler on a website associated with the website resource.

18. The system of claim 17, wherein the internet crawler iteratively reconstructs the website topography to maintain an up-to-date version of the topography of the website.

19. The system of claim 18, wherein receiving a generated website signature descriptive of internet protocol (IP) addresses' access to a website resource comprises calling a name server associated with a domain of the website.

20. The system of claim 16, wherein compare the signatures with the signals to determine if a computing device associated with the signals accessed the website associated with the signatures comprises initiating a brute force comparison, a heuristic comparison, or a combination thereof.
